(19) United States
(12) Patent Application Publication
(10) Pub. No.: US 2004/0067337 A1
(43) Pub. Date: Apr. 8, 2004

(54) Floor mat

(75) Inventor: Andre Lafleur, Boucherville (CA)

Correspondence Address: Mr. S. Peter Ludwig, DARBY & DARBY P.C., 805 Third Avenue, New York, NY, 10022, US

(73) Assignee: LES PROMOTIONS ATLANTIQUES INC.

(21) Appl. No.: 10/263,917

(22) Filed: Oct. 3, 2002

(51) Int. Cl. B32B 3/10

(52) U.S. Cl. 428/138; 428/167

(57) ABSTRACT

A floor mat comprising a substantially flat body having an inner, downwardly recessed area for receiving drainage liquids, and peripheral drainage channels extending from peripheral portions of the recessed area for channelling liquids into the recessed area. The floor mat also comprises a first substantially flat element for absorbing liquids, sized for fitting in the recessed area of the body; and a second substantially flat element pervious to liquid, sized for fitting in the recessed area of the body and disposable over the first element.

### FIELD OF THE INVENTION

The present invention generally relates to floor mats, and more particularly to an absorbing floor mat capable of retaining fluids and designed to protect trouser legs of an user from stain damage due to dirty liquid.

### BACKGROUND OF THE INVENTION

Absorbing floor mat are well known and often used to protect the floor from liquid. More specifically, some absorbing floor mats are provided with a liquid impervious skin for preventing trouser legs of an user to be damaged due to liquid. More particularly, some floor mats are specially designed to be used on the floor of an automobile for protecting the floor carpeting from an accumulation of dirt and water.

Known in the art, there is the U.S. Pat. No. 3,856,610 granted on Dec. 24, 1974 to Charles H. Bruneel. This patent describes a floor mat construction especially suitable for use within the interior of automobiles and other passenger carrying vehicles, and comprising a body portion of a predetermined size and shape fabricated from an absorbent fibrous substrate of sufficient strength to maintain the predetermined shape when wet and supporting a load, such as the automobile passengers feet. The body portion is completely enclosed by a liquid impervious skin such as a polyurethane material with the skin adhering to the surface of the body portion. A portion of the skin associated with the top surface of the body portion is perforated to permit liquid thereon to pass through the skin and into a plurality of aligned bores extending a predetermined depth into the body portion for easy absorption of the liquid therein as well as to trap small particles of mud, dirt and the like.

Also known in the art, there is the U.S. Pat. No. 4,876,135 granted on Oct. 24, 1989 to Blair McIntosh. This patent describes a floor mat comprising a jacket member having a throat opening in a free edge thereof for receiving an insert sheet of absorbent material. The top sheet of the jacket has openings therein for the passage of foreign matter. The insert sheet is disposed under the top sheet and retains foreign matter disposed thereon through the openings in the top sheet. The back surface of the insert is coated with a water resistant coating. After the insert sheet is soiled it can be removed and cleaned or replaced by a new sheet with the soiled sheet discarded.

Also known in the art, there is the U.S. Pat. No. 5,316,817 granted on May 31, 1994 to Clive R. Timperley. This patent describes a vehicular car mat including a tray support having a plurality of recessed cup portions to each receive a multi-layered fibrous insert for ease of removal of the insert for maintenance and cleaning thereof. The support is of a flexible construction having a bottom surface, including a peripheral array of projections directed about the bottom surface, with a second array of projections positioned below the first recessed cup portion onto the bottom surface. The inserts each include a flexible polymeric base, having frictional engaging projections directed from the base for enhanced positioning and adherence within each respective cup portion.

Also known in the art, there is the U.S. Pat. No. 4,420,180 granted on Dec. 13, 1983 to André Dupont and al. This patent describes a floor mat comprising a main portion for lying flat on an automobile floor and an upwardly inclined portion for lying on an inclined surface within the automobile, such as behind the pedals. The main portion includes a centrally disposed downwardly recessed area forming a pan having a floor and surrounding sides for catching fluid. A plurality of ridges, having a triangular cross-section, rise vertically from the floor of the pan for holding pants and the like above fluids caught in the pan. The forwardly extending portion includes ribs which extend in the longitudinal direction of the mat for channeling fluids backward into the pan. Additional ribs are formed on the forward portion which are inclined downwardly and inwardly for channeling fluid away from the edges of the mat toward the center of the mat.

Also known in the art, there are the following U.S. patents which describe different floor mats and fluid absorbing systems: U.S. Pat. Nos. 4,377,614; 4,328,275; 4,379,192; 4,609,580; 4,614,679; 4,650,481; 4,798,754; 4,826,030; 4,950,526; 5,021,277; 5,080,956; 5,114,774; 5,236,753; 5,254,384; 5,270,089; 5,429,854; 5,482,759; 5,500,267; 5,506,040; 5,549,945; 5,607,750; 5,714,229; 5,817,085; 5,962,350; and 5,985,442.

None of the above-mentioned patents provides the necessary means for collecting and retaining liquid and preventing trouser legs of an user to be damaged due to liquid in an efficient manner.

It is therefore an object of the present invention to provide a floor mat for collecting and retaining liquid in a manner more efficient than what is proposed in the prior art.

### SUMMARY OF THE INVENTION

According to the present invention, there is provided a floor mat comprising a substantially flat body having an inner, downwardly recessed area for receiving drainage liquids, and peripheral drainage channels extending all around the recessed area for channelling liquids into the recessed area; a first substantially flat element for absorbing liquids, sized for fitting in the recessed area of the body; and a second substantially flat element pervious to liquid, sized for fitting in the recessed area of the body and disposable over the first element.

### BRIEF DESCRIPTION OF THE DRAWINGS

A detailed description of preferred embodiments will be given herein below with reference to the following drawings, in which like numbers refer to like elements:

FIG. 1 is a top view of a floor mat according to the present invention.

FIG. 2 is a front view of the floor mat shown in FIG. 1.

FIG. 3 is a side view of the floor mat shown in FIG. 1.

FIG. 4 is a top view of another floor mat according to the present invention.

FIG. 5 is a front view of the floor mat shown in FIG. 4.

FIG. 6 is a side view of the floor mat shown in FIG. 4.

FIG. 7 is a bottom view of the floor mats shown in FIGS. 1 to 6.

FIG. 8 is a rear view of the floor mat shown in FIG. 7.

FIG. 9 is an exploded perspective view of the floor mat shown in FIG. 1.

FIG. 10 is a perspective view of a part of the floor mat shown in FIG. 9.

FIG. 11 is an enlarged view of a detail of FIG. 10.

FIG. 12 is an enlarged view of another detail of FIG. 10.

FIG. 13 is a top view of a part of the floor mat shown in FIG. 9.

FIG. 14 is an enlarged view of a detail of FIG. 13.

FIG. 15 is a side view of the part shown in FIG. 13.

FIG. 16 is a perspective view of the part shown in FIG. 13.

FIG. 17 is an enlarged view of a detail of FIG. 16.

The objects, advantages and other features of the present invention will become more apparent upon reading of the following non-restrictive description of a preferred embodiment thereof, given for the purpose of exemplification only with reference to the accompanying drawings.

### DETAILED DESCRIPTION OF THE PREFERRED EMBODIMENTS

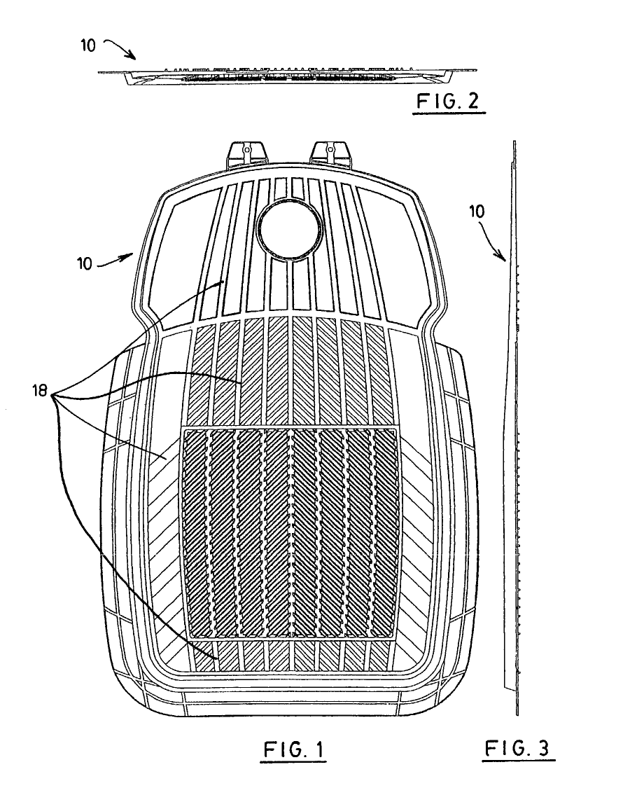

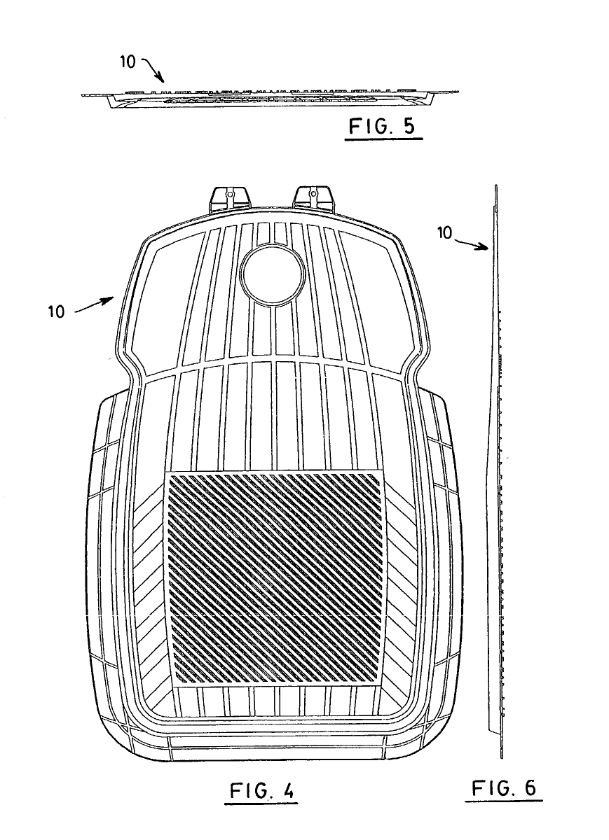

Referring now to FIGS. 1, 2, 3 and 9 to 12, there is shown a floor mat according to the present invention. The floor mat comprises a substantially flat body 10 having an inner, downwardly recessed area 16 for receiving drainage liquids, and peripheral drainage channels 18 extending from peripheral portions of the recessed area 16 for channelling liquids into the recessed area 16. The floor mat also comprises a first substantially flat element 12 for absorbing liquids, sized for fitting in the recessed area 16 of the body 10; and a second substantially flat element 14 pervious to liquid, sized for fitting in the recessed area 16 of the body 10 and disposable over the first element 12.

The body 10 of the floor mat can be flexible for lying on an inclined surface, for example, the surface behind the pedals of an automobile. The body 10 may also have a forward substantially flat portion. The body 10 of the floor mat is preferably made of a material selected from the group comprising polyvinyl chloride, rubber and flexible polymer but other suitable impermeable materials can also be used. For reducing cost production, the body 10 of the floor mat is preferably manufactured by moulding process.

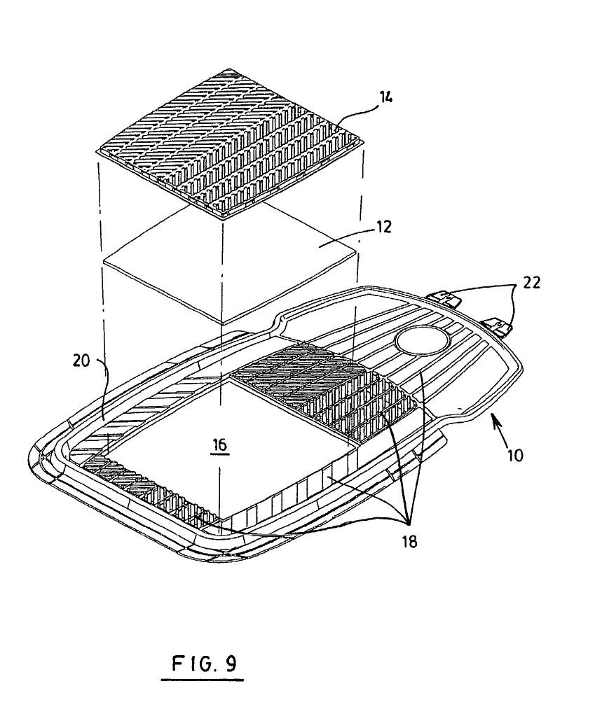

The floor mat may also be provided with fasteners 22, preferably made of a material selected from the group comprising polyvinyl chloride, rubber and flexible polymer and may be integrally moulded with the body 10 for attaching the floor mat in a selected position. For example, it would be useful to attach the floor mat in a selected position for merchandising or store display. As can be seen in FIG. 9, the fasteners, at least two, extend in the longitudinal direction of the floor mat.

The recessed area 16 of the floor mat is preferably rectangular shaped with curved sides for simplifying the manufacturing of the floor mat, but other shapes may be considered. The peripheral drainage channels 18 extend from peripheral portions of the recessed area 16 for channeling liquids therein. The peripheral drainage channels 18 are preferably integrally moulded with the body 10 of the floor mat for reducing cost production of the floor mat.

The first element 12, which is substantially flat, is made of a material for absorbing liquids. This first element 12 may be a three-dimensional polyvinyl chloride grid provided with alveoli for retaining liquid. Preferably, the first element 12 is made of an open cell foam, which can comprise other materials. Preferably, the material of the first element 12 is selected from the group comprising manmade fibres, cellulosic fibres, polyester fibres, reclaimed fibres and polymeric fibres. Preferably, in order to maximise the rapidity and the capacity of retention of the first element, the open cell foam comprises between 10 and 70 cells per inch, and more preferably 30 cells per inch. The use of a foam having about 30 cells per inch is preferable because it presents several different advantages: liquids do not pearl-off on the top of the foam before entering therein; the displacement of liquids inside the foam is minimized during curves of roads in the case the floor mat is used inside a vehicle; the foam retains a part of liquid even if the floor mat is reversed; most of liquid flows out of the floor mat if the floor mat is substantially vertically maintained, this facilitates, then, the cleaning of the floor mat; evaporation of liquid is maximized when the floor mat is exposed to a hot air stream. Moreover, the foam may be a polyurethane foam which can be coated with polyvinyl chloride, or, more preferably, a reticulated polyurethane foam which can also be coated with polyvinyl chloride. Preferably, the foam is an antifungal foam in that it comprises an antifungal substance for avoiding the foam to be damaged too rapidly in preventing the growth of bacterial matter, and, thus, odours. The use of a foam allows an uniform distribution of the collected liquids and, thus, substantially furthers the evaporation of collected liquids, principally by capillarity. The first element 12 is shaped for fitting in the recessed area 16 of the floor mat and is preferably rectangular shaped.

Referring now to FIGS. 4, 5 and 6, there is shown another floor mat 10 according to the present invention having a simpler construction and also preferably manufactured by moulding process.

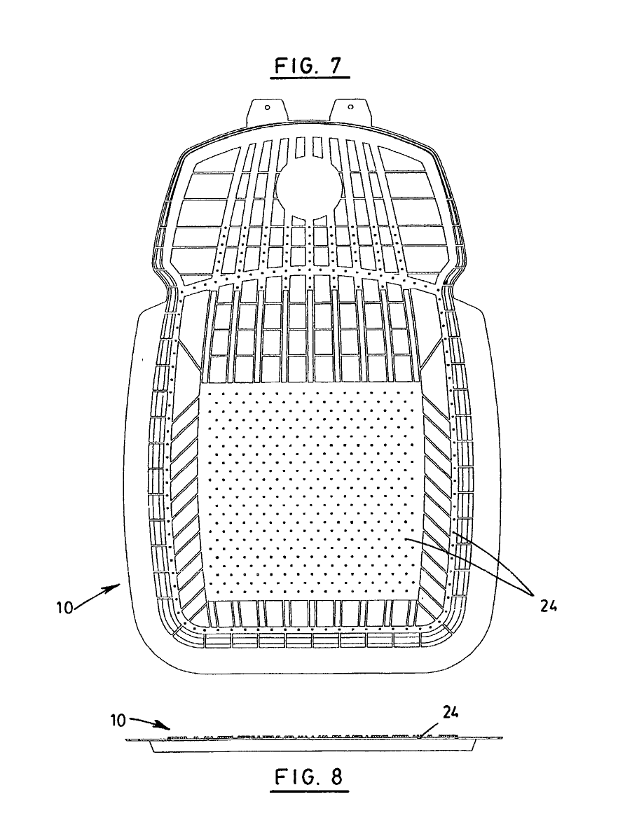

Referring now to FIGS. 7 and 8, there is shown the bottom of a floor mat, preferably provided with small downwardly oriented spikes 24 for providing a better grip on the floor.

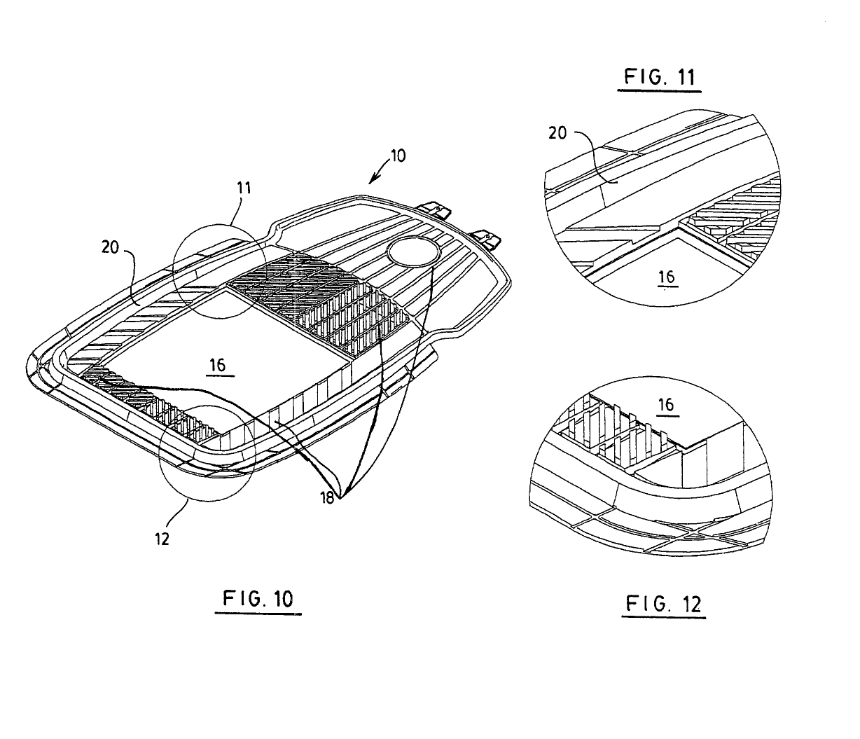

Referring now to FIGS. 10 to 12, there are shown construction details of the floor mat. The body 10 of the floor mat is preferably provided with a substantially vertical edge 20 extending all around the body 10 for preventing collected fluids from spilling out of the floor mat.

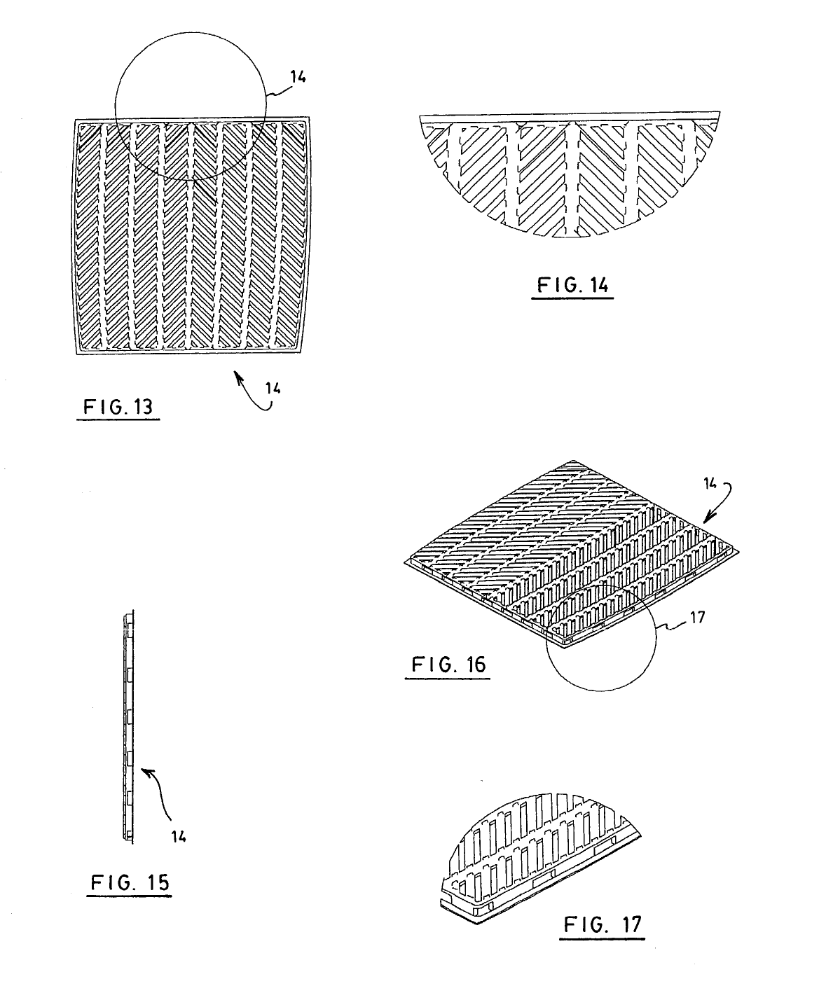

Referring now to FIGS. 13 to 17, there are shown construction details of the flat element 14 which is pervious to liquid. The second element 14 is sized and shaped for fitting in the recessed area 16 of the floor mat and preferably has a rectangular shape with curved sides. The second element 14 is disposable over the first element 12 and is preferably a perforated grid, which can be made of polyvinyl chloride. Of course, any pervious material could be used for the purpose of isolating the collected liquids from the trousers of an user and, thus, preventing damage due to dirty liquid.

Preferably, a glue is used for joining all different elements of the floor mat. The first element 12 is glued to the body 10 and the second element 14 is glued to the first element 12. An urethane glue allows a strong assembly of the different parts of the floor mat but other types of glue could be used. An ultrasound welding could also be used for soldering the different parts of the floor mat. Consequently, the second element 14 could be welded over the body 10 by means of ultrasound for trapping the first element 12 between the body 10 and the second element 14. An infrared welding may also be conveniently used for welding the different elements of the floor mat. The different parts of the floor mat could also just be disposed one over the other without any particular gluing or welding. Moreover, several different techniques mentioned above could be combined to achieve the assembling of the different elements. For example, the first element 12 may be glued to the body 10 and the second element 14 may be infrared weld bound to the first element 12. Other convenient ways to join the elements together may be considered, for example, the second element 14 may be clipped on the rim of the recessed area 16; as a result, no glue would be used and the first element 12 would be interchangeable.

Although a preferred embodiment of the invention has been described in detail herein and illustrated in the accompanying drawings, it is to be understood that the invention is not limited to this precise embodiment and that various changes and modifications may be effected therein without departing from scope or spirit of the invention.

What is claimed is:

1. A floor mat comprising:
a substantially flat body having an inner, downwardly recessed area for receiving drainage liquids, and peripheral drainage channels extending from peripheral portions of the recessed area for channelling liquids into the recessed area;
a first substantially flat element for absorbing liquids, sized for fitting in the recessed area of the body; and
a second substantially flat element pervious to liquid, sized for fitting in the recessed area of the body and disposable over the first element.

2. A floor mat according to claim 1, wherein said body is flexible and has a forward substantially flat portion.

3. A floor mat according to claim 1, wherein said first element is made of an open cell foam.

4. A floor mat according to claim 3, wherein the foam comprises between 10 and 70 cells per inch.

5. A floor mat according to claim 4, wherein the foam comprises 30 cells per inch.

6. A floor mat according to claim 4, wherein said foam is a reticulated polyurethane foam.

7. A floor mat according to claim 6, wherein said foam is coated with polyvinyl chloride.

8. A floor mat according to claim 4, wherein said foam is an antifungal foam.

9. A floor mat according to claim 1, wherein the material of the first element is selected from the group comprising man-made fibres, cellulosic fibres, polyester fibres, reclaimed fibres and polymeric fibres.

10. A floor mat according to claim 1, comprising glue for gluing said first element to the body, and said second element to the first element.

11. A floor mat according to claim 10, wherein said glue is an urethane glue.

12. A floor mat according to claim 1, wherein said first element is welded to the body by means of ultrasound, said second element being welded over the first element by means of ultrasound.

13. A floor mat according to claim 1, wherein said first element is welded to the body by means of infrared, said second element being welded over the first element by means of infrared.

14. A floor mat according to claim 1, wherein said second element is a perforated grid.

15. A floor mat according to claim 13, wherein said perforated grid is made of polyvinyl chloride.

16. A floor mat according to claim 1, wherein said body is made of a material selected from the group comprising polyvinyl chloride, rubber and flexible polymer.
